(19) United States
(12) Patent Application Publication
(10) Pub. No.: US 2026/0016815 A1
(43) Pub. Date: Jan. 15, 2026

(54) SUBSTRATE PROCESSING APPARATUS, SUBSTRATE PROCESSING METHOD, METHOD OF MANUFACTURING SEMICONDUCTOR DEVICE, AND RECORDING MEDIUM

(71) Applicant: Kokusai Electric Corporation, Tokyo (JP)

(72) Inventor: Toshiyuki KIKUCHI, Toyama-shi (JP)

(73) Assignee: Kokusai Electric Corporation, Tokyo (JP)

(21) Appl. No.: 19/338,983

(22) Filed: Sep. 24, 2025

Related U.S. Application Data
(63) Continuation of application No. PCT/JP2023/012016, filed on Mar. 24, 2023.

(51) Int. Cl. G05B 19/418; B08B 5/00; B08B 13/00

(52) U.S. Cl. CPC G05B 19/41865; B08B 5/00; B08B 13/00; G05B 2219/34379

(57) ABSTRACT

Included are: a processing container in which a support capable of supporting at least one substrate is loaded, and in which the substrate is processed; a transfer chamber including a plurality of the supports and capable of switching the supports and transferring the supports to the processing container; a gas supplier that supplies a processing gas for depositing a film and a cleaning gas for removing the deposited film into the processing container; and a controller including a determinator that determines whether a film adhering to the support by the processing of the substrate has reached a cleaning start condition, and capable of controlling a notification indicating that cleaning processing of the support can be performed when the support has reached the cleaning start condition from a determination result of the determinator.

### CROSS-REFERENCE TO RELATED APPLICATION

This application is a Bypass Continuation Application of PCT International Application No. PCT/JP2023/012016, filed on Mar. 24, 2023, the entire contents of which are incorporated herein by reference.

### BACKGROUND

### Field

The present disclosure relates to a substrate processing apparatus, substrate processing method, a method of manufacturing a semiconductor device, and a recording medium.

### Description of the Related Art

As a substrate processing apparatus that processes a substrate, there is known a substrate processing apparatus that includes a processing container and a support that supports the substrate in multiple stages, and performs film formation processing of the substrate in a state where the support is inserted into the processing container. In such a substrate processing apparatus, when the film formation processing of the substrate is repeatedly performed, a film may be accumulated in the processing container or the support. In this case, cleaning to remove the accumulated film is performed on both the processing container and the support.

### SUMMARY

In recent years, a technique has been developed which improves a throughput by preparing a plurality of supports for one processing container and transferring, while a substrate supported by a certain support is processed in the processing container, the substrate to another support. As described above, when a plurality of supports are operated for one processing container, there is a case where the plurality of supports are continuously cleaned. In this case, since the processing container is cleaned for each support, the processing container tends to be over-etched.

The present disclosure provides a technique capable of suppressing over-etching of a processing container caused by cleaning processing of a support that supports a substrate.

According to one aspect of the present disclosure,
there is provided a technique that includes:
a processing container in which a support capable of at least one substrate is loaded and in which the substrate is processed;
a transfer chamber including a plurality of the supports and capable of switching the supports and transferring the supports to the processing container;
a gas supplier that supplies a processing gas for depositing a film and a cleaning gas for removing the deposited film into the processing container; and
a controller including a determinator that determines whether a film adhering to the support by the processing of the substrate has reached a cleaning start condition, and capable of controlling a notification indicating that cleaning processing of the support can be performed when the support has reached the cleaning start condition from a determination result of the determinator.

### BRIEF DESCRIPTION OF THE DRAWINGS

FIG. 1 is a transverse cross-sectional view illustrating a schematic configuration example of a substrate processing apparatus according to one embodiment of the present disclosure.

FIG. 2 is a longitudinal cross-sectional view illustrating a configuration example of the substrate processing apparatus according to one embodiment of the present disclosure.

FIG. 3A is an explanatory diagram illustrating a schematic configuration example of a first gas supplier included in the reactor illustrated in FIG. 2.

FIG. 3B is an explanatory diagram illustrating a schematic configuration example of a second gas supplier included in the reactor illustrated in FIG. 2.

FIG. 4 is a diagram illustrating an example of a configuration of a controller of the substrate processing apparatus according to one embodiment of the present disclosure.

FIG. 5A is an explanatory diagram for explaining an operation of the substrate processing apparatus according to one embodiment of the present disclosure.

FIG. 5B is an explanatory diagram for explaining an operation of the substrate processing apparatus according to one embodiment of the present disclosure.

FIG. 5C is an explanatory diagram for explaining an operation of the substrate processing apparatus according to one embodiment of the present disclosure.

FIG. 5D is an explanatory diagram for explaining an operation of the substrate processing apparatus according to one embodiment of the present disclosure.

FIG. 5E is an explanatory diagram for explaining an operation of the substrate processing apparatus according to one embodiment of the present disclosure.

FIG. 6 is a flowchart illustrating a substrate processing step of the substrate processing apparatus according to one embodiment of the present disclosure.

FIG. 7 is a flowchart of film thickness determination processing of a support of the substrate processing apparatus according to one embodiment of the present disclosure.

FIG. 8 is a flowchart of film thickness determination processing of a processing container of the substrate processing apparatus according to one embodiment of the present disclosure.

FIG. 9 is an example of a setting screen of cleaning information of the substrate processing apparatus according to one embodiment of the present disclosure.

FIG. 10 is an example of a display screen of the cleaning information of the substrate processing apparatus according to one embodiment of the present disclosure.

### DETAILED DESCRIPTION

Hereinafter, an embodiment according to the present disclosure will be described with reference to the drawings.

Note that the drawings used in the following description are all schematic and thus, for example, a dimensional relationship between constituent elements, a ratio between constituent elements, and the like in the drawings do not necessarily coincide with actual ones In addition, a dimensional relationship between elements, a ratio between elements, and the like do not necessarily coincide among a plurality of drawings.

### (1) Configuration of Substrate Processing Apparatus

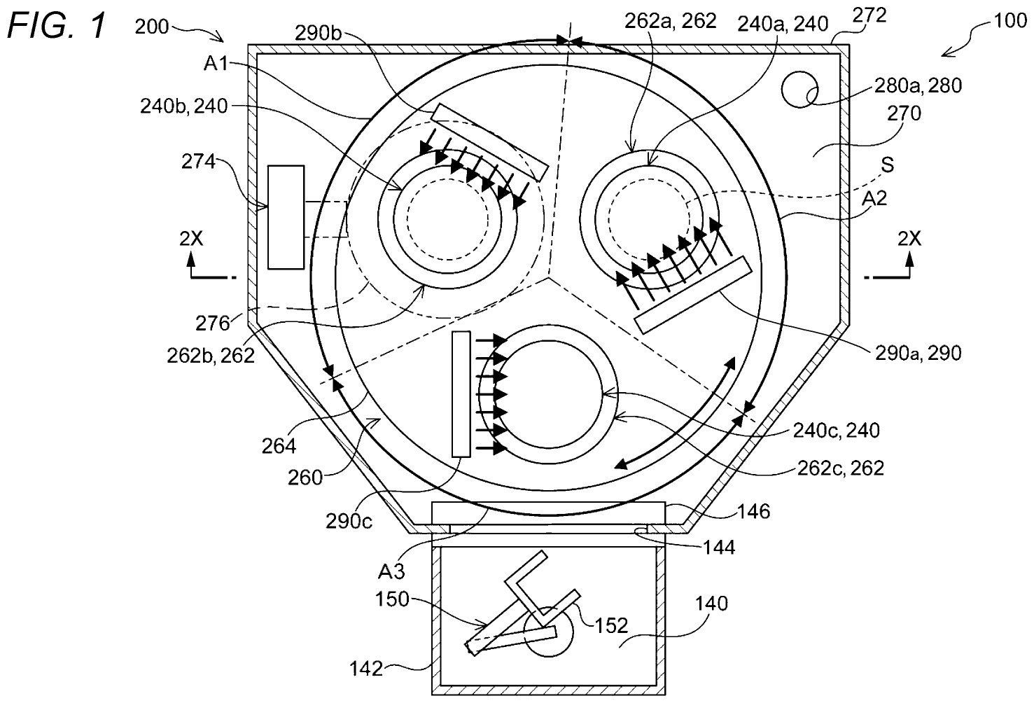

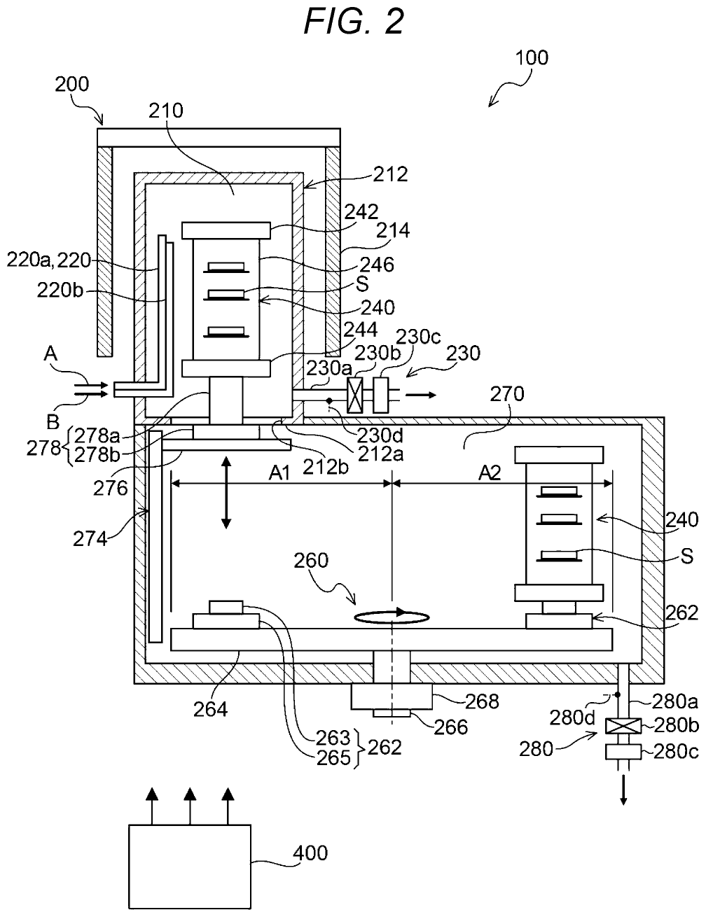

An outline configuration of a substrate processing apparatus according to one embodiment of the present disclosure will be described with reference to FIGS. 1 and 2. FIG. 1 is a transverse cross-sectional view illustrating a schematic configuration example of a substrate processing apparatus according to the present technology. FIG. 2 is a longitudinal cross-sectional view illustrating a schematic configuration example of the substrate processing apparatus according to one embodiment of the present disclosure, and is also a cross-sectional view taken along an arrow 2X-2X in FIG. 1.

FIGS. 1 and 2 illustrate a substrate processing apparatus 100 to which the technology of the present disclosure is applied. The substrate processing apparatus 100 is an apparatus that processes a substrate S. The substrate processing apparatus 100 includes a transfer chamber 140, a reactor 200, a transfer chamber 270, and a controller 400.

### <Transfer Chamber 140>

The transfer chamber 140 is a chamber for transferring the substrate S under a negative pressure. The transfer chamber 140 is constituted by a housing 142. Note that although not illustrated, a vacuum device for reducing the pressure in the transfer chamber 140 to a negative pressure is connected to the transfer chamber 140. The inside of the transfer chamber 140 is set to a negative pressure by this vacuum device.

The transfer chamber 140 is configured to communicate with the transfer chamber 270. Specifically, the transfer chamber 140 communicates with the transfer chamber 270 through an inlet/outlet 144 formed in a housing 272 constituting the transfer chamber 270. The inlet/outlet 144 is used as a passage for loading the substrate S from the transfer chamber 140 into the transfer chamber 270 and unloading the substrate S from the transfer chamber 270 into the transfer chamber 140. The inlet/outlet 144 is opened and closed by a gate valve 146 attached to the housing 272.

A transfer robot 150 that transfers the substrate S under a negative pressure is disposed in the transfer chamber 140. The transfer robot 150 has an arm 152 including an end effector. The transfer robot 150 is configured to be capable of ascending, descending, and rotating by an elevator (not illustrated) and a rotator (not illustrated) while airtightness of the transfer chamber 140 is maintained.

The transfer robot 150 receives the substrate S before being processed by the reactor 200 from a device outside the transfer chamber 140, and loads the received substrate S into the transfer chamber 270. In addition, the transfer robot 150 loads out the substrate S after being processed by the reactor 200 from the transfer chamber 270, and delivers the unloaded substrate S to a device outside the transfer chamber 140. In the present embodiment, the substrate S before being processed by the reactor 200 is referred to as an unprocessed substrate S.

### <Reactor 200>

The reactor 200 is a chamber capable of processing the substrate S. The reactor 200 is, for example, a chamber for performing processing such as forming a thin film on a surface of the substrate S.

The reactor 200 includes a process chamber 210. Note that the process chamber 210 is positioned on an upper side of the transfer chamber 270. Note that the upper side as used herein indicates an upper side in the vertical direction. A lower side indicates a lower side in the vertical direction. The vertical direction in the present embodiment is the same direction as an up and down direction of the substrate processing apparatus 100. Hereinafter, the upper side and the lower side in the vertical direction are simply referred to as “upper side” and “lower side” in an abbreviated manner, respectively.

The process chamber 210 is a chamber capable of performing substrate processing including processing of heating the substrate S. The process chamber 210 is mainly constituted by a reaction tube 212 serving as an example of a processing container. In addition, a plurality of boats 240 are each individually transferred to the process chamber 210 to perform substrate processing. In other words, the process chamber 210 performs substrate processing while replacing the plurality of boats 240.

On an outer peripheral side of the reaction tube 212, a heater 214 serving as a heater that heats the boat 240 and the substrate S supported by the boat 240 through the reaction tube 212 is disposed. The heater 214 is separated from an outer peripheral wall of the reaction tube 212. In the present embodiment, a resistance heater is used as the heater 214. Note that as the heater 214, a heater other than the resistance heater may be used as long as the boat 240 and the substrate S supported by the boat 240 can be heated.

An upper end of the reaction tube 212 is closed. A flange portion 212a protruding radially inward of the reaction tube 212 is disposed at a lower end of the reaction tube 212. A center of the flange portion 212a is opened to form a furnace opening 212b. The boat 240 moves between the process chamber 210 and the transfer chamber 270 through the furnace opening 212b.

The reaction tube 212 is configured to be capable of housing the boat 240 that supports the substrate S. Note that, in an internal space of the reaction tube 212, a region in which the boat 240 that supports the substrate S is stored is referred to as a processing region, and a section constituting the processing region is referred to as the process chamber 210.

The reaction tube 212 includes a plurality of nozzles 220. These nozzles 220 pass through a peripheral wall of the reaction tube 212 and extend to the upper side from the lower side. Each of the nozzles 220 has a plurality of gas holes (not illustrated) at intervals in an extending direction. Gas supplied from the gas holes of the nozzle 220 is supplied to the substrate S supported by the boat 240 in the process chamber 210.

The nozzle 220 is disposed for each type of gas, for example. In the present embodiment, two nozzles 220a and 220b are used as an example. The nozzles 220 are disposed so as not to overlap each other in the horizontal direction.

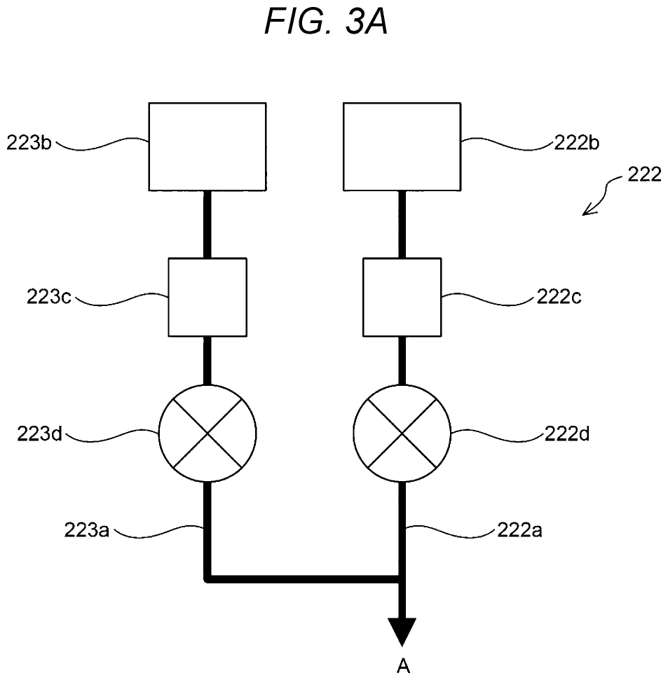

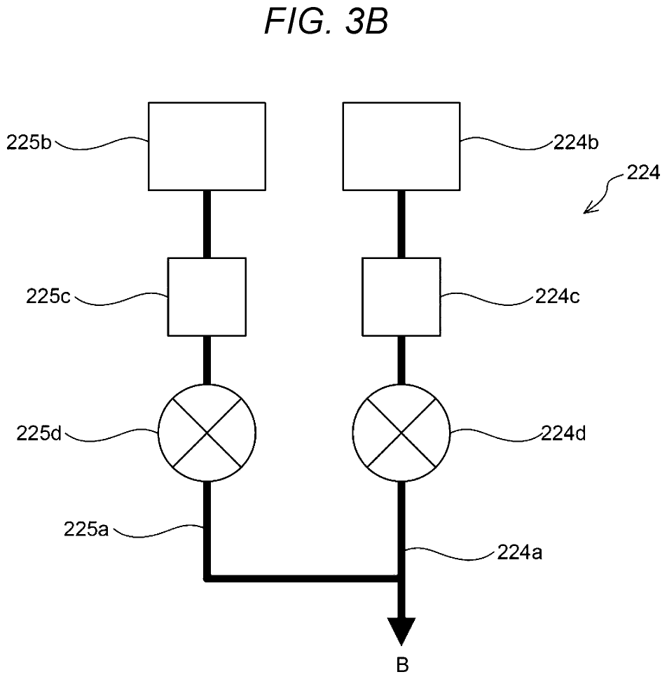

As illustrated in FIG. 3A, a first gas is supplied to the nozzle 220a from a first gas supplier 222. That is, the first gas supplier 222 is configured to supply the first gas to the nozzle 220a. The first gas supplier 222 includes a gas supply pipe 222a, a mass flow controller (MFC) 222c which is a flow rate controller, and a valve 222d which is an on-off valve. The gas supply pipe 222a includes a first gas source 222b, the MFC 222c, and the valve 222d in this order from an upstream direction. The gas supply pipe 222a is configured to communicate with the nozzle 220a. The first gas source 222b may be included in the first gas supplier 222.

The first gas source 222b is a first gas (also referred to as “first element-containing gas”) source containing a first element. The first element-containing gas is one of source gases, that is, processing gases. Here, the first element is, for example, silicon (Si). Specifically, the first element-containing gas is a chlorosilane source gas containing a Si—Cl bond, such as a hexachlorodisilane (Si₂Cl₆, abbreviation: HCDS) gas, a monochlorosilane (SiH₃Cl, abbreviation: MCS) gas, a dichlorosilane (SiH₂Cl₂, abbreviation: DCS) gas, a trichlorosilane (SiHCl₃, abbreviation: TCS) gas, a tetrachlorosilane (SiCl₄, abbreviation: STC) gas, or an octachlorotrisilane (Si₃Cl₈, abbreviation: OCTS) gas. Note that the first gas supplier 222 is also referred to as a silicon-containing gas supplier.

Also as illustrated in FIG. 3A, a cleaning gas is supplied to the nozzle 220a from a first cleaning gas supplier 223. That is, the first cleaning gas supplier 223 is configured to supply the cleaning gas to the nozzle 220a. The first cleaning gas supplier 223 includes a gas supply pipe 223a, an MFC 223c, and a valve 223d. The gas supply pipe 223a includes a first cleaning gas source 223b, the MFC 223c, and the valve 223d in this order from an upstream direction. The gas supply pipe 223a is connected to a portion of the gas supply pipe 222a on a downstream side of the valve 222d. The gas supply pipe 223a is configured to communicate with the nozzle 220a through the gas supply pipe 222a. The first cleaning gas source 223b may be included in the first cleaning gas supplier 223.

The first cleaning gas source 223b is a cleaning gas (also referred to as “fluorine-containing gas”) source containing fluorine. As the cleaning gas, it is possible to use, for example, a chlorine trifluoride (ClF₃) gas, a chlorine fluoride (ClF) gas, a nitrogen trifluoride (NF₃) gas, a hydrogen fluoride (HF) gas, a fluorine (F₂) gas, or the like. One or more of these gases can be used as the cleaning gas.

As illustrated in FIG. 3B, a second gas is supplied to the nozzle 220b from a second gas supplier 224. That is, the second gas supplier 224 is configured to supply the second gas to the nozzle 220b. The second gas supplier 224 includes a gas supply pipe 224a, an MFC 224c, and a valve 224d. The gas supply pipe 224a includes a second gas source 224b, the MFC 224c, and the valve 224d in this order from an upstream direction. The gas supply pipe 224a is configured to communicate with the nozzle 220b. The second gas source 224b may be included in the second gas supplier.

The second gas source 224b is a second gas (hereinafter, also referred to as “second element-containing gas”) source containing a second element. The second element-containing gas is one of processing gases. Note that the second element-containing gas may be considered as a reactant gas or a modifying gas.

Here, the second element-containing gas contains the second element different from the first element. The second element is, for example, any one of oxygen (O), nitrogen (N), and carbon (C). In the present embodiment, the second element-containing gas is, for example, a nitrogen-containing gas. Specifically, the second element-containing gas is a hydrogen nitride-based gas containing an N—H bond, such as ammonia (NH₃), a diazene (N₂H₂) gas, a hydrazine (N₂H₄) gas, or an N₃H₈ gas. Note that the second gas supplier 224 is also referred to as a reactant gas supplier.

Also as illustrated in FIG. 3B, a cleaning gas is supplied to the nozzle 220b from a second cleaning gas supplier 225. That is, the second cleaning gas supplier 225 is configured to supply the cleaning gas to the nozzle 220b. The second cleaning gas supplier 225 includes a gas supply pipe 225a, an MFC 225c, and a valve 225d. The gas supply pipe 225a includes a second cleaning gas source 225b, the MFC 225c, and the valve 225d in this order from an upstream direction. The gas supply pipe 225a is connected to a portion of the gas supply pipe 224a on a downstream side of the valve 224d. The gas supply pipe 225a is configured to communicate with the nozzle 220b through the gas supply pipe 224a. The second cleaning gas supplier 225 may include the second cleaning gas source 225b.

The second cleaning gas source 225b is a cleaning gas (also referred to as “fluorine-containing gas”) source containing fluorine. Note that the second cleaning gas source 225b of the present embodiment is a cleaning gas having the same properties as the first cleaning gas source 223b, and therefore description thereof is omitted.

In the present embodiment, the number of the nozzles 220 is two, but the present disclosure is not limited to this configuration. The number of the nozzles 220 may be set to three or more according to the contents of substrate processing. For example, a dedicated nozzle for supplying a cleaning gas may be disposed, or a dedicated nozzle for supplying an inert gas may be disposed.

As illustrated in FIG. 2, an exhauster 230 is connected to the reaction tube 212. The exhauster 230 performs vacuum-exhaust such that a pressure in the reaction tube 212 is a predetermined pressure (degree of vacuum). The exhauster 230 includes an exhaust pipe 230a, a valve 230b, and an auto pressure controller (APC) valve 230c serving as a pressure regulator. The exhauster 230 may include a vacuum pump (not illustrated) connected to a downstream of the exhaust pipe 230a. The exhaust pipe 230a communicates with the inside of the reaction tube 212. A vacuum pump is connected to the exhaust pipe 230a via a valve 230b and a valve 230c. In addition, the exhauster 230 may include a pressure detector 230d having a function of detecting a pressure in the reaction tube 212. Note that the pressure in the reaction tube 212 is regulated by cooperation of the above-described gas supplier and the exhauster 230. When the pressure is regulated, for example, a pressure value detected by the pressure detector 230d may be regulated to a predetermined value.

### <Transfer Chamber 270>

As illustrated in FIG. 2, the transfer chamber 270 is a chamber for transferring the boat 240 and the substrate S to the reactor 200. The transfer chamber 270 is a chamber to which the substrate S can also be transferred through the inlet/outlet 144 by the transfer robot 150 in the transfer chamber 140. Although details will be described later, in the transfer chamber 270, the boat 240 that supports the substrate S is switched, and the boat 240 is transferred to the reactor 200. The transfer chamber 270 includes a plurality of the boats 240, a revolution rotator 260, and a cooler 290.

The transfer chamber 270 is positioned on a lower side of the process chamber 210 and is configured to communicate with the process chamber 210. Specifically, a lower end of the reaction tube 212 is connected to an upper portion (ceiling portion) of the housing 272 configuring the transfer chamber 270. The transfer chamber 270 communicates with the inside of the reaction tube 212 through the furnace opening 212b.

The inlet/outlet 144 for loading in and out the substrate S is formed on a side wall of the housing 272. The inlet/outlet 144 is opened and closed by the gate valve 146. In the transfer chamber 270, the substrate S is placed (mounted) on the boat 240 through the inlet/outlet 144 by the transfer robot 150, or the substrate S is taken out from the boat 240 by the transfer robot 150.

The transfer chamber 270 includes a boat elevator 274. The boat elevator 274 is an apparatus capable of raising and lowering the boat 240. The boat elevator 274 includes a lid body 276 that supports the boat 240. The lid body 276 rises and is lowered, whereby the boat 240 moves between the transfer chamber 270 and the process chamber 210. The lid body 276 is a member that closes the furnace opening 212b. Therefore, the diameter of the lid body 276 is configured to be larger than the diameter of the furnace opening 212b. Note that an O-ring serving as a sealing member may be disposed on a lower surface of the flange portion 212a of the reaction tube 212 or an upper surface of the lid body 276. In a case of disposing the O-ring, when the boat 240 is set at a predetermined position of the process chamber 210, the O-ring is crushed and deformed between the flange portion 212a and the lid body 276. As a result, the inside of the reaction tube 212 is kept more airtight. The lid body 276 may include a heater. By inclusion of the heater in the lid body 276, a temperature of the substrate S disposed on a lower side of the boat 240 and a temperature of the substrate S disposed on an upper side of the boat 240 can be maintained at the same level.

A boat support 278 that supports the boat 240 is disposed on the lid body 276. The boat support 278 includes a rotation shaft 278a and a rotation mechanism 278b. The rotation shaft 278a extends in the up and down direction. A bottom plate portion 244 of the boat 240 is connected to an upper end of the rotation shaft 278a. When the rotation shaft 278a is rotated in a state where the bottom plate portion 244 of the boat 240 is connected to the upper end of the rotation shaft 278a, the boat 240 is rotated with respect to the lid body 276. For example, the boat 240 housed in the process chamber 210 is rotated by the rotation of the rotation shaft 278a. In addition, the rotation mechanism 278b is fixed to the lid body 276. The rotation mechanism 278b rotatably supports the rotation shaft 278a.

The boat elevator 274 moves the lid body 276 to a lower side and receives the boat 240 from a boat support 262 on the revolution rotator 260 at the upper end of the rotation shaft 278a. When receiving the boat 240, the boat elevator 274 raises the lid body 276. Then, the boat elevator 274 houses the boat 240 in the process chamber 210. In addition, the boat elevator 274 lowers the lid body 276 and takes out the boat 240 from the process chamber 210 after substrate processing of the substrate S in the process chamber 210 is ended. Then, the boat elevator 274 delivers the boat 240 from the rotation shaft 278a on the lid body 276 to the boat support 262 on the revolution rotator 260.

An exhauster 280 is connected to the transfer chamber 270. The exhauster 280 is an apparatus that performs vacuum-exhaust such that a pressure in the transfer chamber 270 is a predetermined pressure (degree of vacuum). The exhauster 280 includes an exhaust pipe 280a, a valve 280b, an APC valve 280c, and a vacuum pump (not illustrated). The exhaust pipe 280a communicates with the transfer chamber 270. A vacuum pump is connected to the exhaust pipe 280a via the valve 280b and the valve 280c. In addition, the exhauster 280 may include a pressure detector 280d having a function of detecting a pressure in the transfer chamber 270.

The boat 240 is a support capable of supporting the substrate S. The boat 240 is configured to be capable of supporting at least one substrate S. The boat 240 is configured to support a plurality of substrates S at intervals in the up and down direction in a case of supporting the plurality of substrates S. The boat 240 includes a top plate portion 242, a bottom plate portion 244, and a support 246. The support 246 is positioned between the top plate portion 242 and the bottom plate portion 244. In addition, the support 246 includes a plurality of mounting tables (not illustrated) on which the plurality of substrates S can be supported at intervals in the up and down direction. In other words, in the support 246, the plurality of substrates S can be supported in multiple stages in the up and down direction by the plurality of mounting tables. Note that, in the present embodiment, three boats 240 are used as an example, and a boat A is defined as a boat 240a, a boat B is defined as a boat 240b, and a boat C is defined as a boat 240c. In the present embodiment, the boat 240 may indicate any one or all of the boat 240a, the boat 240b, and the boat 240c.

As illustrated in FIG. 1, the revolution rotator 260 is an apparatus capable of causing the boat 240 to revolve. The revolution rotator 260 includes the boat support 262, a revolution table 264, a revolution shaft 266, and a revolution mechanism 268.

The boat support 262 is a portion that supports the boat 240. A plurality of boat supports 262 are disposed on the revolution table 264. Specifically, the plurality of boat supports 262 are disposed at intervals in a rotation direction of the revolution table 264. In the present embodiment, as an example, three boat supports 262 are disposed on the revolution table 264. The boat support 262 includes a boat support 262a corresponding to the boat 240a, a boat support 262b corresponding to the boat 240b, and a boat support 262c corresponding to the boat 240c. In addition, in the present embodiment, the boat support 262 may indicate any one or all of the boat support 262a, the boat support 262b, and the boat support 262c. In addition, the boat support 262 includes a rotation shaft 263 and a rotation mechanism 265. The rotation shaft 263 extends in the up and down direction from the revolution table 264. An upper end of the rotation shaft 263 is detachably connected to the bottom plate portion 244 of the boat 240. When the rotation shaft 263 is rotated in a state where the bottom plate portion 244 is connected to the upper end of the rotation shaft 263, the boat 240 is rotated with respect to the revolution table 264. For example, a direction of the boat 240 can be regulated by the boat 240 being rotated when the substrate S is transferred by the transfer robot 150. The rotation mechanism 265 is fixed to the revolution table 264 and rotatably supports the rotation shaft 263.

The plurality of boat supports 262 are disposed on an upper surface of the revolution table 264. The revolution shaft 266 is connected to a central portion of the revolution table 264. The revolution table 264 is rotated by rotation of the revolution shaft 266. The rotation of the revolution table 264 causes the boat support 262 to revolve around the revolution shaft 266.

The revolution shaft 266 is connected to the revolution table 264. The revolution shaft 266 extends in the up and down direction and penetrates a bottom wall of the transfer chamber 270. The revolution shaft 266 rotates the revolution table 264 by a rotational force from the revolution mechanism 268 to cause the boat support 262 to revolve. The revolution mechanism 268 is controlled by the controller 400 described later.

The revolution mechanism 268 is disposed on a lower surface of a bottom wall of the transfer chamber 270 and rotatably supports the revolution shaft 266. For example, the boat 240 is moved from a position adjacent to the inlet/outlet 144 to a lower side of the process chamber 210 by causing the revolution table 264 to revolve to move. Specifically, when the boat is moved to a next area, the revolution table 264 is rotated so as to cause the boat to revolve by approximately 120 degrees depending on a situation.

A plurality of coolers 290 are disposed on the revolution table 264 according to the plurality of boats 240. For example, a cooler 290a is disposed in the boat 240a described later, a cooler 290b is disposed in the boat 240b described later, and a cooler 290c is disposed in the boat 240c described later.

As illustrated in FIG. 1, the transfer chamber 270 includes a first area A1, a second area A2, and a third area A3 in an area on an upper side of the revolution rotator 260. Note that the first area A1 and the second area A2 are also illustrated in FIG. 2.

The first area A1 is an area in which the boat 240 can be moved between the revolution rotator 260 and the boat elevator 274. Specifically, in the first area A1, the boat 240 is moved between the boat support 262 of the revolution rotator 260 and the boat support 278 of the boat elevator 274. The first area A1 is disposed on a lower side of the process chamber 210. At least the furnace opening 212b is included in the first area A1 when viewed from above.

The second area A2 is an area in which the boat 240 and the substrate S after heating processing can be caused to stand by. In addition, the second area A2 is an area in which the boat 240 and the substrate S after heating processing can also be cooled. Specifically, in the second area A2, an inert gas is sent from the cooler 290 toward the boat 240 and the substrate S after heating processing. As a result, the substrate S after heating processing is cooled. The second area A2 is disposed downstream of the first area A1 in a rotation direction when the revolution rotator 260 is rotated clockwise.

The third area A3 is an area adjacent to the transfer chamber 140 and capable of transferring the substrate S to and from the transfer chamber 140. Specifically, the transfer robot 150 delivers the unprocessed substrate S to the boat 240 positioned in the third area A3, or receives the processed substrate S from the boat 240 positioned in the third area A3. In this manner, the substrate S is transferred between the third area A3 and the transfer chamber 140. In the third area A3, the boat 240 is disposed at a position facing the inlet/outlet 144, and the transfer robot 150 is configured to be capable of transferring the substrate S.

In the present embodiment, as illustrated in FIG. 1, for the sake of convenience, the first area A1, the second area A2, and the third area A3 are set as areas of equal angles (120 degrees) about a rotation shaft of the revolution rotator 260. That is, the sizes of the first area A1, the second area A2, and the third area A3 are set to be the same. The present disclosure is not limited to this configuration. The size of each area may be appropriately set. In addition, different areas from the first area A1, the second area A2, and the third area A3 may be newly set.

### <Controller>

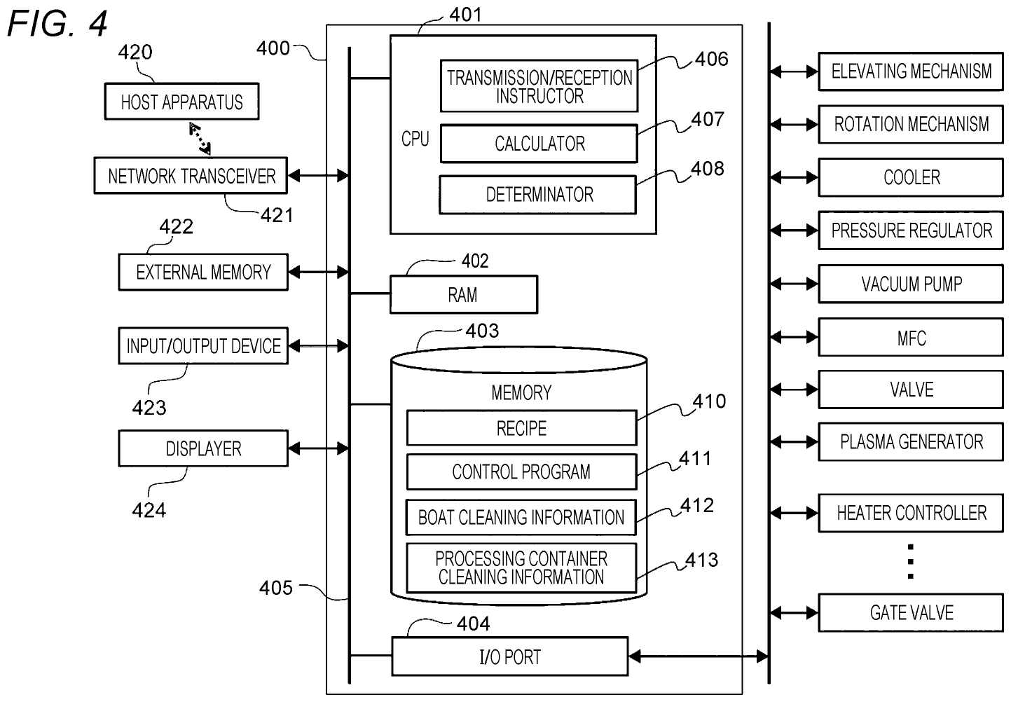

Next, the controller 400 will be described with reference to FIG. 4.

The controller 400 controls the operation of each constituent of the substrate processing apparatus 100.

The controller 400 serving as a controller (control means) is configured as a computer including a central processing unit (CPU) 401, a random access memory (RAM) 402, a memory 403 serving as a memory, and an I/O port 404. The RAM 402, the memory 403, and the I/O port 404 are configured to be capable of exchanging data with the CPU 401 via an internal bus 405. Transmission/reception of data in the substrate processing apparatus 100 is performed by an instruction from a transmission/reception instructor 406, which is one of functions of the CPU 401. Calculation in the substrate processing apparatus 100 is performed by a calculator 407, which is one of functions of the CPU 401. Selection of each operation in the substrate processing apparatus 100 is performed by determination by a determinator 408, which is one of functions of the CPU 401. In addition, the determinator 408 of the present embodiment can determine whether a film adhering to the boat 240 by processing of the substrate S has reached a cleaning start condition.

The CPU 401 is configured to read and execute a control program from the memory 403, and to read a process recipe from the memory 403 in response to an input of an operation command from an input/output device 423 or the like. Then, the CPU 401 is configured to be capable of controlling, for example, an opening/closing operation of the gate valve 146, on/off control of each pump, a flow rate regulating operation of the MFC, an opening/closing operation of a valve, and the like, according to the contents of the read process recipe. Note that the input/output device 423 is connected to a displayer 424 such as a display capable of displaying a processing state of the substrate S via the internal bus 405. In addition, the input/output device 423 may be directly connected to the displayer 424. When the input/output device 423 is a touch panel having a function of the displayer 424, the displayer 424 may be omitted.

The memory 403 includes, for example, a flash memory or a hard disk drive (HDD). In the memory 403, a recipe 410 including, for example, a process recipe in which procedures, conditions, and the like of substrate processing are described, a control program 411 for controlling an operation of the substrate processing apparatus, boat cleaning information 412 in which cleaning information of each boat is stored, processing container cleaning information 413 in which cleaning information of the reaction tube 212 serving as a processing container is stored, and the like are stored in a readable manner.

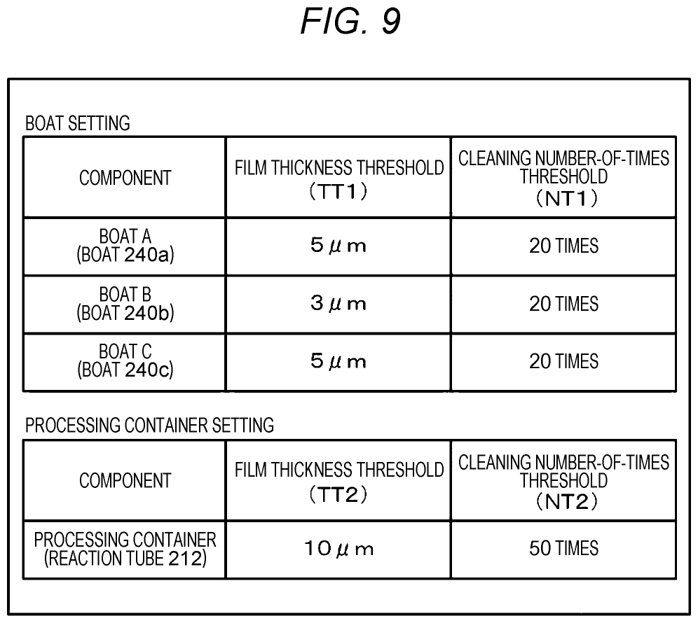

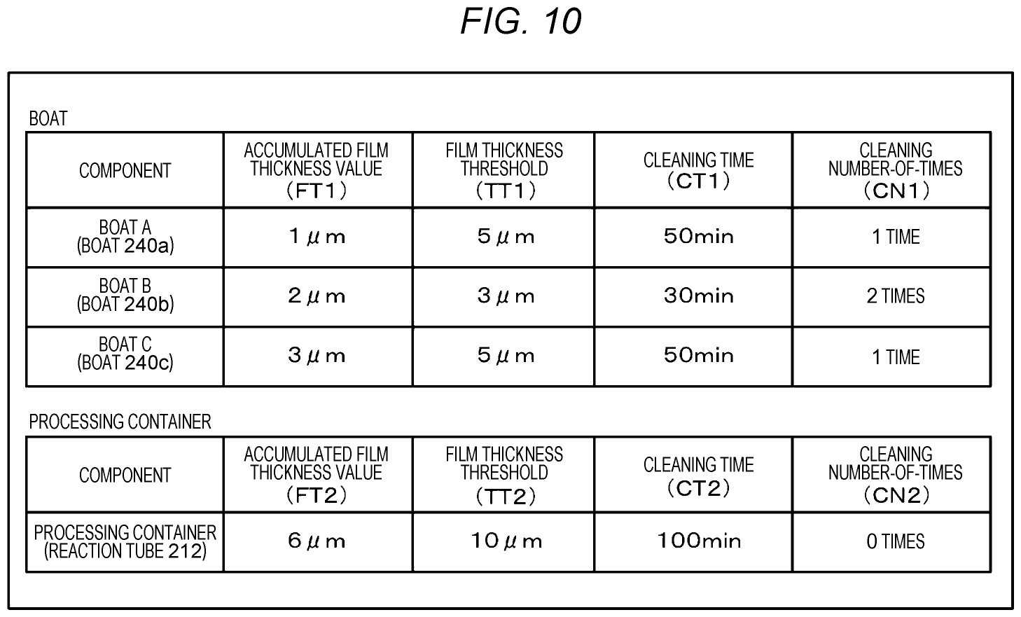

The boat cleaning information 412 includes a film thickness threshold TT1 (TT1a corresponds to a film thickness threshold of the boat 240a, TT1b corresponds to a film thickness threshold of the boat 240b, and TT1c corresponds to a film thickness threshold of the boat 240c) serving as a cleaning start condition of each of the plurality of boats 240 and a number-of-times threshold NT1 (NT1a corresponds to a cleaning number-of-times threshold of the boat 240a, NT1b corresponds to a cleaning number-of-times threshold of the boat 240b, and NT1c corresponds to a cleaning number-of-times threshold of the boat 240c) serving as a cleaning number-of-times threshold. In addition, the boat cleaning information 412 includes an accumulated film thickness value FT1 (FT1a corresponds to an accumulated film thickness value of the boat 240a, FT1b corresponds to an accumulated film thickness value of the boat 240b, and FT1c corresponds to an accumulated film thickness value of the boat 240c) and a cleaning number-of-times CN1 (CN1a corresponds to a cleaning number-of-times of the boat 240a, CN1b corresponds to a cleaning number-of-times of the boat 240b, and CN1c corresponds to a cleaning number-of-times of the boat 240c) of a film adhering to each boat 240 in the substrate processing. In the present embodiment, the film thickness threshold TT1 and the number-of-times threshold NT1 of each boat 240 are set using the input/output device 423. An input screen (setting screen) of the film thickness threshold TT1 and the number-of-times threshold NT1 of each boat 240 is a screen illustrated in FIG. 9. Note that, in the present embodiment, an operator inputs the film thickness threshold TT1 using the input/output device 423, whereby a cleaning time CT1 is automatically set, but the cleaning time CT1 may be manually set. A value of each boat 240 stored in the memory is displayed on the displayer 424 (see FIG. 10).

The processing container cleaning information 413 includes a film thickness threshold TT2 serving as a cleaning start condition of the reaction tube 212 and a number-of-times threshold NT2 serving as a cleaning number-of-times threshold. In addition, the processing container cleaning information 413 includes an accumulated film thickness value FT2 and the cleaning number-of-times CN2 of a film adhering to the inside of the reaction tube 212 in the substrate processing. In the present embodiment, the film thickness threshold TT2 and the number-of-times threshold NT2 are set using the input/output device 423. An input screen (setting screen) of the film thickness threshold TT2 and the number-of-times threshold NT2 of the reaction tube 212 is a screen illustrated in FIG. 9. Note that, in the present embodiment, an operator inputs the film thickness threshold TT2 using the input/output device 423, whereby a cleaning time CT2 is automatically set, but the cleaning time CT2 may be manually set. A set value is displayed on the displayer 424 (see FIG. 10).

Note that the process recipe functions as a program for causing the controller 400 to execute each procedure in the substrate processing step described below to obtain a predetermined result.

Hereinafter, the process recipe, the control program, and the like will also be collectively and simply referred to as a program. Note that the term “program” in the present specification may include only the process recipe, may include only the control program, or may include both thereof. The RAM 402 is configured as a memory area (working area) in which a program, data, or the like read by the CPU 401 is temporarily stored.

The I/O port 404 is connected to each component such as the gate valve 146, each pressure regulator, each pump, or a heater controller. Furthermore, a network transceiver 421 connected to a host apparatus 420 via a network is disposed.

Note that, the controller 400 according to this technology can be configured by, for example, installing a program in a computer using an external memory 422 that stores the above-described program. Note that examples of the external memory 422 include a magnetic disk such as a hard disk, an optical disk such as a DVD, a magneto-optical disk such as an MO, and a semiconductor memory such as a USB memory. In addition, a program supplier to the computer is not limited to a case of supplying a program via the external memory 422. For example, a program may be supplied using a communicator such as the Internet or a dedicated line without using the external memory 422. Note that the memory 403 and the external memory 422 are configured as computer-readable recording media. Hereinafter, the memory 403 and the external memory 422 will also be collectively and simply referred to as recording media. Note that, the term “recording medium” in the present specification may include only the memory 403, may include only the external memory 422, or may include both thereof.

Next, an operation of the cleaning processing of the boat 240 and the reaction tube 212 by the controller 400 will be described. Note that, in the present embodiment, three boats 240 are disposed in the revolution rotator 260.

When the determinator 408 determines that any of the boats 240 has reached the cleaning start condition, the controller 400 performs control such that the boat 240 serving as a cleaning processing target (hereinafter, appropriately abbreviated as “processing target”) determined to have reached the cleaning start condition and the reaction tube 212 are subjected to the cleaning processing according to the cleaning time CT1 set for the boat 240 serving as a processing target. In addition, the controller 400 performs control to notify the displayer 424 of display of the fact that the boat 240 serving as a processing target determined to have reached the cleaning start condition has reached the cleaning start condition. Note that, in the present embodiment, the displayer 424 is notified of the fact that the boat 240 has reached the cleaning start condition, but the notification destination is not limited to the displayer, and for example, the host apparatus 420 may be notified of the fact via the network transceiver 421.

Here, the determinator 408 sets a time point at which the accumulated film thickness value FT1 of a film (deposit) adhering to each boat 240 is equal to or more than the film thickness threshold TT1 preset for each boat 240 as the cleaning start condition for each boat 240. That is, when the accumulated film thickness value FT1 of any one of the boats 240 is equal to or more than the film thickness threshold TT1 set for the boat 240, the controller 400 transfers the boat 240 as a processing target into the reaction tube 212 (process chamber 210) and performs cleaning processing on the boat 240. Note that, in the present embodiment, the cleaning start condition of the boat 240 is defined as the film thickness threshold TT1, but the present disclosure is not limited thereto, and for example, a threshold serving as a use period of the boat 240 may be calculated from the film thickness threshold TT1 as a use time of the boat 240 and used as the cleaning start condition of the boat 240.

The accumulated film thickness value FT1 can be obtained on the basis of a film thickness estimation value analogized from the number of times of use, a use time, and the like in which each boat 240 is used in the substrate processing step. Note that the accumulated film thickness value FT1 may be an accumulated film thickness value detected by a film thickness detector (not illustrated) disposed in the process chamber 210 or the transfer chamber 270.

The controller 400 calculates the cleaning time CT1 of each boat 240 on the basis of the film thickness threshold TT1 or the accumulated film thickness value FT1 of each boat 240. In the present embodiment, a parameter of a cleaning time with respect to a film thickness value is stored in the memory 403, and the calculator 407 automatically calculates the cleaning time according to the input cleaning start condition (film thickness threshold TT1) or accumulated film thickness value FT1. Note that the cleaning time CT1 corresponding to the accumulated film thickness value FT1 may be stored in advance in the memory 403, and the cleaning time CT1 corresponding to the input cleaning start condition (film thickness threshold TT1) may be set. Alternatively, the cleaning time CT1 corresponding to the accumulated film thickness value FT1 may be acquired from the memory 403.

When the controller 400 performs cleaning processing of the boat 240 serving as a cleaning processing target and the reaction tube 212, the controller 400 updates the cleaning number-of-times CN1 of the boat 240 that has been subjected to the cleaning processing. Furthermore, when the controller 400 completes the cleaning processing of the boat 240, the controller 400 clears (zero-clears) the accumulated film thickness value FT1 of the boat 240 for which the cleaning processing is completed.

The controller 400 determines whether the accumulated film thickness value FT1 is equal to or more than the film thickness threshold TT1 in each boat 240, and causes the displayer 424 to display a determination result. Specifically, the determinator 408 of the controller 400 determines whether the accumulated film thickness value FT1 is equal to or more than the film thickness threshold TT1. Then, the controller 400 causes the displayer 424 to display a result determined by the determinator 408.

The controller 400 restricts use of the boat 240 in which the cleaning number-of-times CN1 is equal to or more than the preset number-of-times threshold NT1. Specifically, as an example, the boat 240 whose use is restricted can be used for thin film processing of the substrate S and cannot be used for thick film processing of the substrate S. In addition, the controller 400 notifies the displayer 424 of display of the fact that there is the boat 240 whose use is restricted.

When the determinator 408 determines that the reaction tube 212 has reached the cleaning start condition, the controller 400 performs control such that the reaction tube 212 is subjected to the cleaning processing according to the cleaning time CT2 set for the reaction tube 212. In addition, the controller 400 performs control to notify the displayer 424 of display of the fact that the reaction tube 212 has reached the cleaning start condition. Note that, in the present embodiment, the displayer 424 is notified of the fact that the reaction tube 212 has reached the cleaning start condition, but the notification destination is not limited to the displayer 424, and for example, the host apparatus 420 may be notified via the network transceiver 421.

Here, the determinator 408 sets a time point at which the accumulated film thickness value FT2 of a film (deposit) adhering to the reaction tube 212 is equal to or more than the film thickness threshold TT2 preset for the reaction tube 212 as the cleaning start condition for the reaction tube 212. That is, when the accumulated film thickness value FT2 of the reaction tube 212 is equal to or more than the film thickness threshold TT2 set for the reaction tube 212, the controller 400 performs the cleaning processing on the reaction tube 212 as a cleaning processing target. When the cleaning processing is performed on the reaction tube 212, the boat 240 does not stay in the reaction tube 212. That is, the cleaning processing of the reaction tube 212 is performed in a state where the reaction tube 212 is empty. That is, the controller 400 performs control such that only the reaction tube 212 is subjected to the cleaning processing according to the cleaning time CT2 of the reaction tube 212. Note that, in the present embodiment, the cleaning start condition of the reaction tube 212 is defined as the film thickness threshold TT2, but the present disclosure is not limited thereto, and for example, a threshold serving as a use period of the reaction tube 212 may be calculated from the film thickness threshold TT2 as a use time of the reaction tube 212 and used as the cleaning start condition of the reaction tube 212.

The accumulated film thickness value FT2 can be obtained on the basis of a film thickness estimation value analogized from the number of times of use, a use time, and the like in which the reaction tube 212 is used in the substrate processing step. Note that the accumulated film thickness value FT2 may be an accumulated film thickness value detected by a film thickness detector (not illustrated) disposed in the process chamber 210.

The controller 400 calculates the cleaning time CT2 of the reaction tube 212 on the basis of the film thickness threshold TT2 of the reaction tube 212. In the present embodiment, a parameter of a cleaning time with respect to a film thickness value of the reaction tube 212 is stored in the memory 403, and the calculator 407 automatically calculates the cleaning time according to the input cleaning start condition (film thickness threshold TT2) or accumulated film thickness value FT2. Note that the cleaning time CT2 corresponding to the accumulated film thickness value FT2 may be stored in the memory 403, and the cleaning time CT2 corresponding to the input cleaning start condition (film thickness threshold TT2) may be set. Alternatively, the cleaning time CT2 corresponding to the accumulated film thickness value FT2 may be acquired from the memory 403.

When performing the cleaning processing of the reaction tube 212, the controller 400 updates the cleaning number-of-times CN2 of the reaction tube 212. Furthermore, when the controller 400 completes the cleaning processing of the reaction tube 212, the controller 400 clears (zero-clears) the accumulated film thickness value FT2 of the reaction tube 212.

The controller 400 determines whether the accumulated film thickness value FT2 is equal to or more than the film thickness threshold TT2 in the reaction tube 212, and causes the displayer 424 to display a determination result. Specifically, the determinator 408 of the controller 400 determines whether the accumulated film thickness value FT2 is equal to or more than the film thickness threshold TT2. Then, the controller 400 causes the displayer 424 to display a result determined by the determinator 408.

The controller 400 restricts use of the reaction tube 212 when the cleaning number-of-times CN2 is equal to or more than the preset number-of-times threshold NT2. Specifically, as an example, the reaction tube 212 whose use is restricted can be used for thin film processing of the substrate S and cannot be used for thick film processing of the substrate S. In addition, the controller 400 causes the displayer 424 to display that there is the reaction tube 212 whose use is restricted.

### (2) Substrate Processing Step

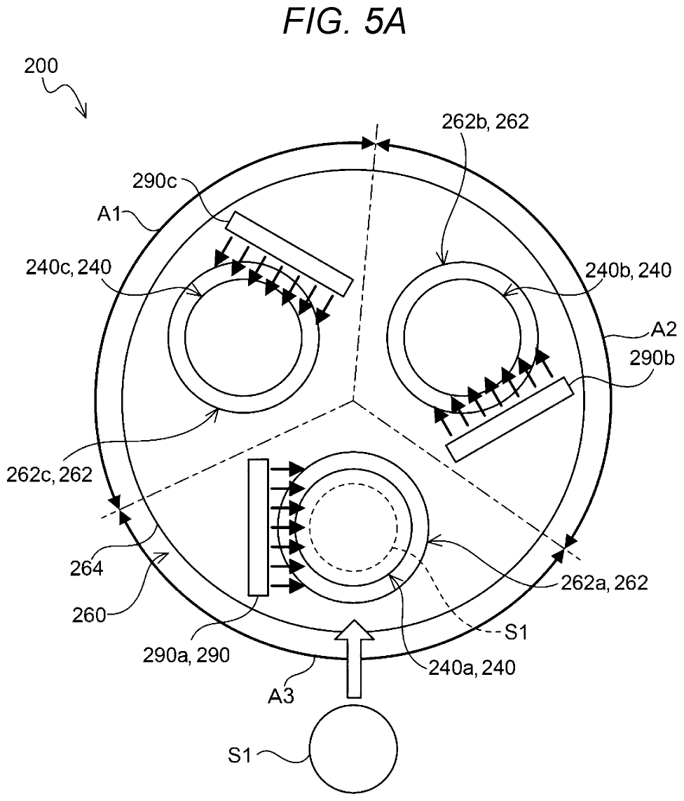

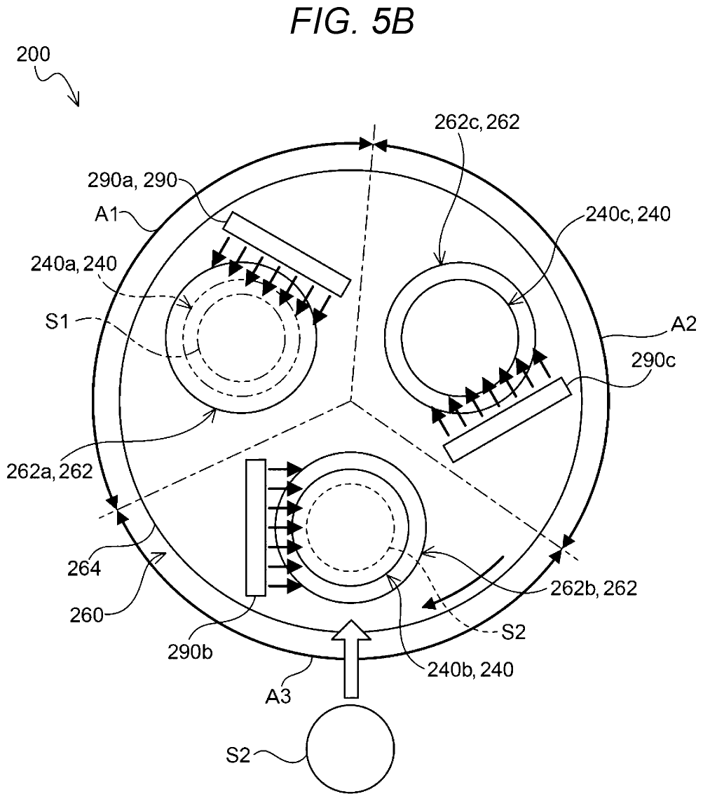

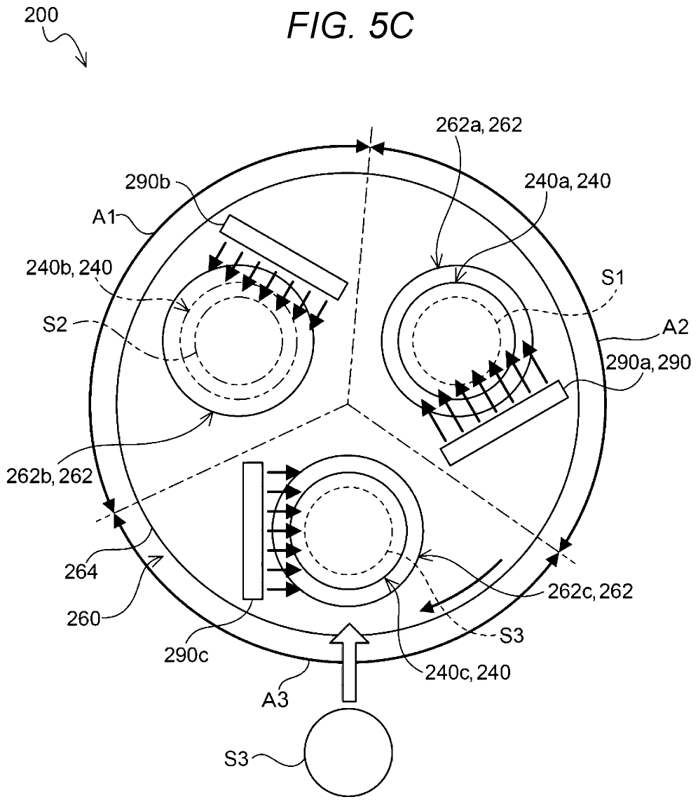

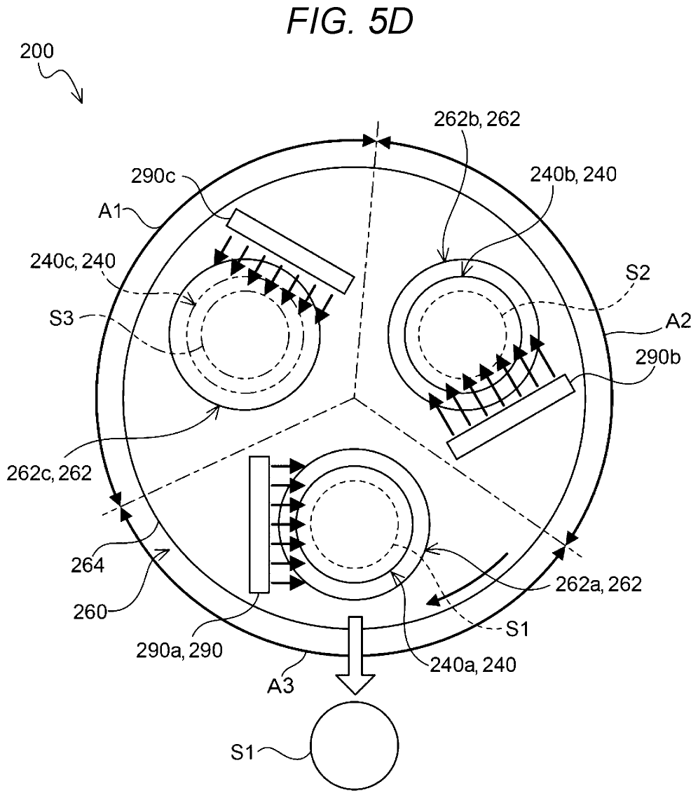

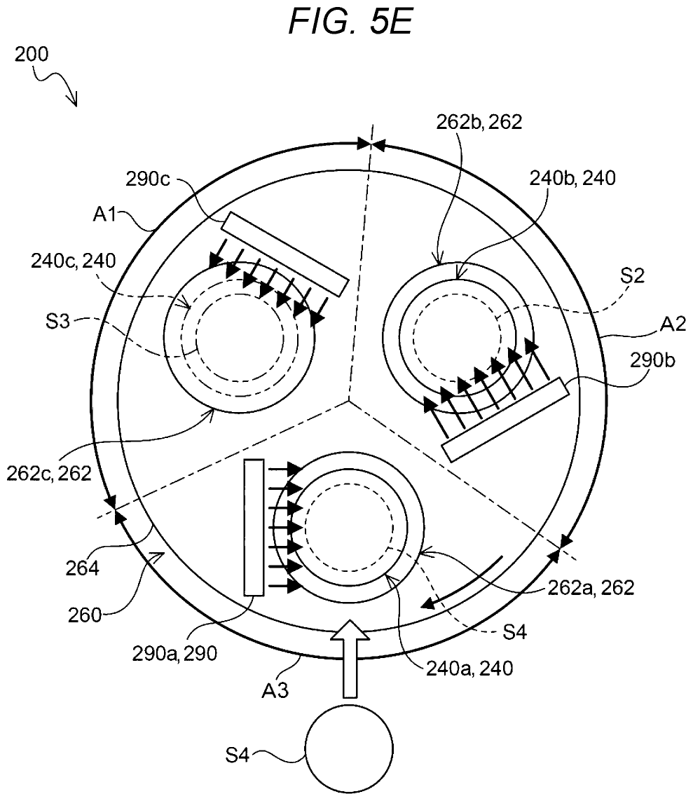

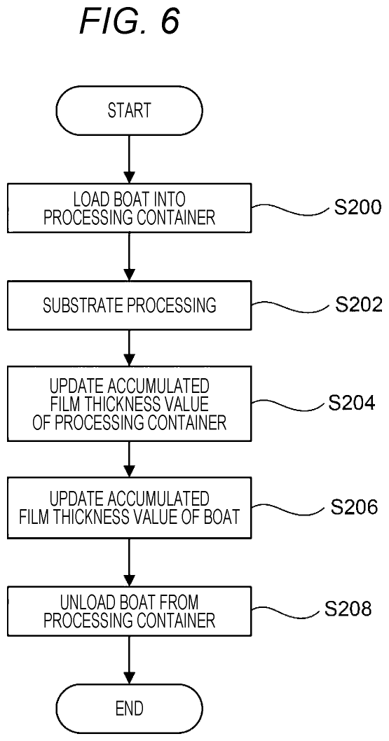

Next, the substrate processing step will be described with reference to FIGS. 5A to 5E and 6. As one step of the substrate processing apparatus, a step of processing the substrate S using the substrate processing apparatus 100 having the above-described configuration will be described. Note that in the following description, an operation of each unit constituting the substrate processing apparatus is controlled by the controller 400.

First, as illustrated in FIG. 5A, the substrate S is transferred from the transfer chamber 140 to the boat 240a in the third area A3 of the transfer chamber 270 using the transfer robot 150. Here, the substrate S to be transferred to the boat 240a is denoted by reference numeral S1 for convenience.

Next, as illustrated in FIG. 5B, due to the rotation of the revolution rotator 260 (clockwise rotation in FIG. 5B), the boat 240a that supports the substrate S1 revolves to move from the third area A3 to the first area A1, and the boat 240b (appropriately referred to as the “empty boat 240”) that does not support the substrate revolves to move from the second area A2 to the third area A3. Here, the substrate S2 is transferred from the transfer chamber 140 to the empty boat 240b that has moved to the third area A3 using the transfer robot 150.

When the boat 240a that supports the substrate S1 moves to the first area A1, the boat 240a rises while being supported by the boat elevator 274. Then, the boat 240a is housed in the process chamber 210. That is, the boat 240a positioned in the first area A1 is loaded into the process chamber 210 (step S200).

The boat 240a housed in the process chamber 210 is subjected to heating processing. That is, a first gas and a second gas are supplied to the substrate S1 supported by the boat 240a, and a film is formed by substrate processing including the heating processing. The substrate processing is performed on the substrate S1 in this manner (step S202).

Since the film thickness of a film adhering to an inner surface of the reaction tube 212 is increased by the substrate processing of the substrate S1, the accumulated film thickness value FT2 of the reaction tube 212 is updated (step S204).

In addition, since the film thickness of a film adhering to the boat 240a used for the substrate processing of the substrate S1 is increased, the accumulated film thickness value FT1a of the boat 240a is updated (step S206).

Next, a pressure between the process chamber 210 and the transfer chamber 270 is regulated, and the boat 240a is unloaded from the process chamber 210 by the boat elevator 274 (step S208). The boat 240a unloaded from the process chamber 210 is delivered to the boat support 262a in the first area A1 of the revolution rotator 260.

As illustrated in FIG. 5C, the boat 240a unloaded from the process chamber 210 revolves to move from the first area A1 to the second area A2 by the rotation of the revolution rotator 260. The boat 240a that has moved to the second area A2 is cooled by an inert gas sent from the cooler 290a. That is, the substrate S1 supported by the boat 240a is cooled by the inert gas.

In addition, due to the rotation of the revolution rotator 260, the empty boat 240c revolves to move from the second area A2 to the third area A3. Here, the substrate S3 is transferred from the transfer chamber 140 to the empty boat 240c that has moved to the third area A3 using the transfer robot 150.

On the other hand, the boat 240b that supports the substrate S2 moves from the third area A3 to the first area A1 by the rotation of the revolution rotator 260, and rises while being supported by the boat elevator 274. Then, the boat 240b is housed in the process chamber 210 and subjected to heating processing. That is, a first gas and a second gas are supplied to the substrate S2 supported by the boat 240b, and a film is formed by substrate processing including the heating processing. The substrate processing is performed on the substrate S2 in this manner.

After the substrate processing of the substrate S2, the accumulated film thickness value FT2 of the reaction tube 212 and the accumulated film thickness value FT1b of the processed boat 240b are updated.

Next, a pressure between the process chamber 210 and the transfer chamber 270 is regulated, and the boat 240b is unloaded from the process chamber 210 by the boat elevator 274. The boat 240b unloaded from the process chamber 210 is delivered to the boat support 262b in the first area A1 of the revolution rotator 260.

As illustrated in FIG. 5D, the boat 240b unloaded from the process chamber 210 revolves to move from the first area A1 to the second area A2 by the rotation of the revolution rotator 260. The boat 240b that has moved to the second area A2 is cooled by an inert gas sent from the cooler 290b. That is, the substrate S2 supported by the boat 240b is cooled by the inert gas. On the other hand, the boat 240a that supports the substrates S1 for which the cooling processing is ended moves to the third area A3. In the third area A3, the processed substrate S1 is unloaded from the boat 240a by the transfer robot 150.

As illustrated in FIG. 5E, the transfer robot 150 transfers a new substrate S4 to the boat 240a from which the substrate S1 has been taken out.

In addition, the boat 240c that supports the substrate S3 moves from the third area A3 to the first area A1 by the rotation of the revolution rotator 260, and rises while being supported by the boat elevator 274. Then, the boat 240c is housed in the process chamber 210 and subjected to heating processing. That is, a first gas and a second gas are supplied to the substrate S3 supported by the boat 240c, and a film is formed by substrate processing including the heating processing. The substrate processing is performed on the substrate S3 in this manner.

After the substrate processing of the substrate S3, the accumulated film thickness value FT2 of the reaction tube 212 and the accumulated film thickness value FT1c of the processed boat 240c are updated.

After the transfer of the substrate S4 to the boat 240a is ended, the boat 240a that supports the substrate S4 moves from the third area A3 to the first area A1.

As described above, in the present embodiment, since the substrate processing is performed while the three boats 240a, 240b, and 240c are individually replaced with each other in the reaction tube 212, the substrate processing can be continuously performed. Therefore, in the present embodiment, productivity of the substrate processing is improved.

### (3) Cleaning Processing Step

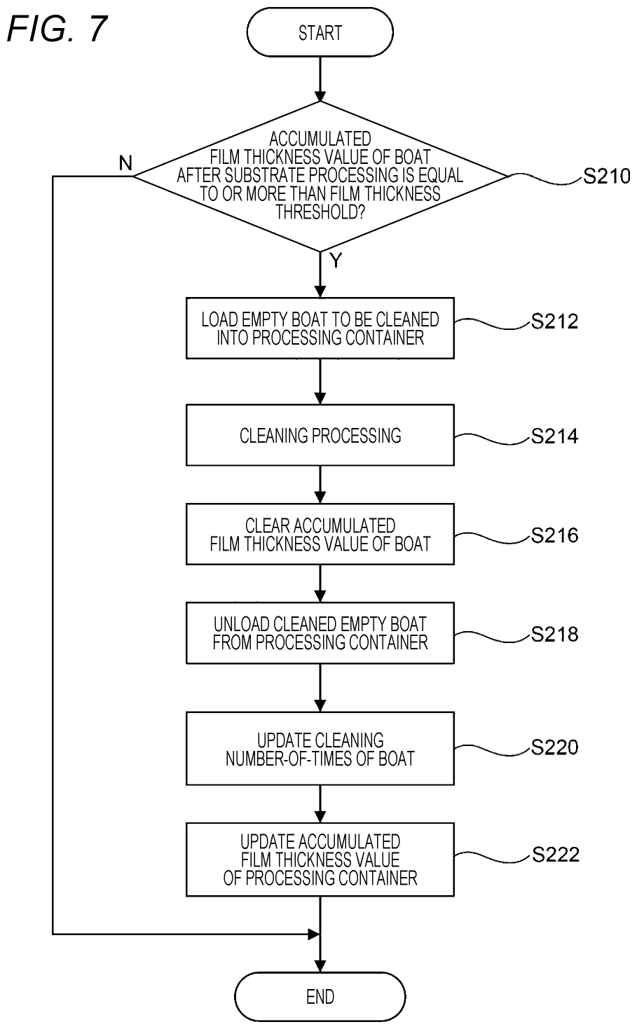

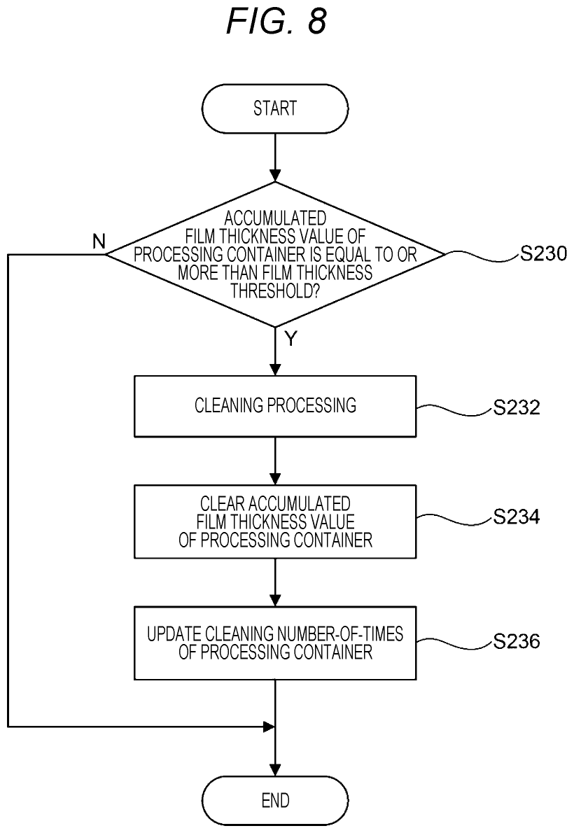

Next, a cleaning processing step will be described with reference to FIGS. 7 and 8. As one step of the substrate processing apparatus, a step of performing the cleaning processing on the boat 240 and the reaction tube 212 of the substrate processing apparatus 100 having the above-described configuration will be described. Note that, in the following description, the controller 400 controls an operation of each unit constituting the substrate processing apparatus 100. In addition, the following description will be given using the boat A (boat 240a) as an example of the boat 240 with which substrate processing is performed. Note that the same applies to a case where the substrate processing is performed using the boat B (boat 240b) or the boat C (boat 240c), which is not described below.

First, when the substrate processing of the substrates S is ended in the substrate processing step, the accumulated film thickness value FT2 of the processing container (reaction tube 212) is updated in step S204. In addition, in step S206, the accumulated film thickness value FT1a of the boat 240a used for the substrate processing is updated. At this time, as illustrated in FIG. 7, the controller 400 determines whether or not the accumulated film thickness value FT1a of the boat 240a immediately after the substrate processing is equal to or more than the film thickness threshold TT1a (step S210). This determination is made by the determinator 408 of the controller 400. When the determinator 408 determines that the accumulated film thickness value FT1a is less than the film thickness threshold TT1a, the process is ended without performing the cleaning processing of the boat 240 immediately after the substrate processing. On the other hand, when the determinator 408 determines that the accumulated film thickness value FT1a is equal to or more than the film thickness threshold TT1a, the process proceeds to step S212 in order to perform the cleaning processing of the boat 240a immediately after the substrate processing.

In step S212, the empty boat 240a serving as a cleaning processing target is loaded into the reaction tube 212. Specifically, the empty boat 240a is loaded into the process chamber 210. Here, when it is determined that the boat 240a immediately after the substrate processing is a cleaning processing target, all the substrates S may be discharged from the boat 240a serving as a cleaning processing target before the next substrate processing is performed in the reaction tube 212, and the boat 240a serving as a cleaning processing target may be emptied and then loaded into the process chamber 210. Alternatively, while the substrate processing of a substrate supported by another boat 240a is continued, the boat 240a serving as a cleaning processing target may be loaded into the process chamber 210 without supporting a new substrate S. When the loading of the empty boat 240a into the process chamber 210 is completed, the process proceeds to step S214.

In step S214, cleaning processing is performed on the boat 240a serving as a cleaning processing target and the reaction tube 212 using a cleaning gas according to a predetermined procedure. When the cleaning processing is ended, the process proceeds to step S216.

In step S216, the accumulated film thickness value FT1a of the boat that has been subjected to the cleaning processing (hereinafter, appropriately referred to as “cleaned boat”) 240a is cleared (zero-cleared). Then, the process proceeds to step S218.

In step S218, the cleaned boat 240a is unloaded from the process chamber 210. Then, the process proceeds to step S220.

In step S220, the cleaning number-of-times CN1a of the cleaned boat 240a is updated. Then, the process proceeds to step S222.

In step S222, a value obtained by subtracting the value of the accumulated film thickness value FT1a before performing the cleaning processing of the cleaned boat from the accumulated film thickness value FT2 of the reaction tube 212 that has been subjected to the cleaning processing together with the boat 240a serving as a cleaning processing target is updated as the accumulated film thickness value FT2. When step S222 is ended, the cleaning processing of the boat 240a is ended.

Note that steps S216, S218, S220, and S222 may be appropriately replaced with each other for operation.

In addition, as illustrated in FIG. 8, the controller 400 determines whether or not the accumulated film thickness value FT2 of the reaction tube 212 immediately after the substrate processing is equal to or more than the film thickness threshold TT2 (step S230). This determination is made by the determinator 408 of the controller 400. When the determinator 408 determines that the accumulated film thickness value FT2 is less than the film thickness threshold TT2, the process is ended without performing the cleaning processing of the reaction tube 212 immediately after the substrate processing. On the other hand, when the determinator 408 determines that the accumulated film thickness value FT2 is equal to or more than the film thickness threshold TT2, the process proceeds to step S232 in order to perform the cleaning processing of the reaction tube 212.

In step S232, cleaning processing is performed using a cleaning gas according to a predetermined procedure in a state where the inside of the reaction tube 212, that is, the process chamber 210 is empty. When the cleaning processing is ended, the process proceeds to step S234.

In step S234, the accumulated film thickness value FT2 of the reaction tube 212 is cleared (zero-cleared). Then, the process proceeds to step S236.

In step S236, the cleaning number-of-times CN2 of the reaction tube 212 is updated. When step S236 is ended, the cleaning processing of the reaction tube 212 is ended.

In the present embodiment, the cleaning processing of the boat 240 is determined immediately after the substrate processing, and then the cleaning processing of the reaction tube 212 is determined. However, the present disclosure is not limited to this configuration, and the cleaning processing of the reaction tube 212 may be determined, and then the cleaning processing of the boat 240 may be determined.

In addition, in the present embodiment, the determination of the cleaning processing of the boat 240 and the reaction tube 212 is made before the substrate processing step is ended, but the present disclosure is not limited to this configuration. For example, the determination of the cleaning processing of the boat 240 and the reaction tube 212 may be made after the boat 240 after the substrate processing is unloaded from the process chamber 210. In addition, the determination of the cleaning processing of the boat 240 may be made when the substrate S is transferred in the third area A3.

Next, effects of the present embodiment will be described.

When it is determined that the accumulated film thickness value FT1 of any one of the boats 240 is equal to or more than the film thickness threshold TT1 serving as the cleaning start condition, the substrate processing apparatus 100 of the present embodiment performs the cleaning processing on the reaction tube 212 and the boat 240 serving as a processing target in which the accumulated film thickness value FT1 is determined to be equal to or more than the film thickness threshold TT1 serving as the cleaning start condition according to the cleaning time CT1 set for the boat 240 serving as a processing target. Here, since the cleaning processing of the reaction tube 212 and the boat 240 serving as a processing target is performed according to the cleaning time CT1 of the boat 240, a film slightly remains in the reaction tube 212 used more frequently than each of the boats 240. That is, since the cleaning processing of the reaction tube 212 is performed according to the cleaning time CT1 of the boat 240, the accumulated film thickness value FT2 of the reaction tube 212 is unlikely to be zero. Since the film remains on an inner surface of the reaction tube 212 in this manner, it is possible to suppress occurrence of over-etching in the reaction tube 212 due to a cleaning gas when the boat 240 is subjected to the cleaning processing together with the reaction tube 212. Therefore, since the substrate processing apparatus 100 of the present embodiment performs the cleaning processing only on the boat 240 that has reached the cleaning start condition, for example, a life of the reaction tube 212 can be extended as compared with a case where the cleaning processing is collectively performed on all the boats 240. It is also possible to suppress a decrease in production efficiency.

Furthermore, when it is determined that the accumulated film thickness value FT2 of the reaction tube 212 is equal to or more than the film thickness threshold TT2 serving as the cleaning start condition, the substrate processing apparatus 100 of the present embodiment controls each unit of the substrate processing apparatus 100 so as to perform cleaning processing on the reaction tube 212 according to the cleaning time CT2. Here, since the cleaning processing of the reaction tube 212 is performed according to the cleaning time CT2 of the reaction tube 212, the cleaning number-of-times of the reaction tube 212 can be suppressed. As a result, the number of times of occurrence of over-etching of the reaction tube 212 can be reduced, and a life of the reaction tube 212 can be extended. Furthermore, in the cleaning processing of the reaction tube 212, since the cleaning processing is performed only on the reaction tube 212, it is possible to suppress occurrence of over-etching in the boat 240.

In the present embodiment, when the cleaning processing is performed, the cleaning number-of-times CN1 of the boat 240 that has been subjected to the cleaning processing is updated. That is, the controller 400 updates the cleaning number-of-times CN1 included in the boat cleaning information 412 stored in the memory 403. In addition, when performing the cleaning processing of the reaction tube 212, the controller 400 updates the cleaning number-of-times CN2. That is, the controller 400 updates the cleaning number-of-times CN1 included in the boat cleaning information 412 stored in the memory 403 and the cleaning number-of-times CN2 included in the processing container cleaning information 413 stored in the memory 403. Therefore, even when the substrate processing apparatus 100 is restarted, since setting contents are stored in the memory 403, the setting contents stored in the memory 403 can be taken out after the restart, and the setting contents can be reused. That is, the substrate processing apparatus 100 of the present embodiment can eliminate a step of setting information for each restart, and can suppress a decrease in production efficiency.

In the substrate processing apparatus 100 of the present embodiment, use of the boat 240 in which the cleaning number-of-times CN1 is equal to or more than the preset number-of-times threshold NT1 is restricted. Here, the controller 400 stores the cleaning number-of-times CN1 of performing the cleaning processing for each boat 240 in the memory 403 as the boat cleaning information 412. There is a possibility that the boat 240 is over-etched by performing the cleaning processing on the boat 240. Therefore, there is a possibility that the boat 240 cannot withstand the substrate processing by repeating the cleaning processing. In this case, the boat 240 is replaced. As described above, a life of the boat 240 can be grasped by setting the number-of-times threshold NT1 to the cleaning number-of-times CN1 of each boat 240. Then, the controller 400 gives a notification of a replacement time of the boat 240 before the boat 240 becomes unusable (in other words, before an end of the life). Specifically, the determinator 408 of the controller 400 compares the cleaning number-of-times CN1 with the number-of-times threshold NT1, and when the cleaning number-of-times CN1 is equal to or more than the number-of-times threshold NT1, the determinator 408 notifies the displayer 424 of display of the fact that the target boat 240 is being used. By displaying that there is the boat 240 whose use is restricted in this manner on the displayer 424, an operator can recognize that there is the boat 240 to be replaced. Note that a notification of the presence of the boat 240 whose use is restricted may be given by voice, or the presence of the boat 240 whose use is restricted may be displayed on an external displayer or the like via a communication line.

In the substrate processing apparatus 100 of the present embodiment, use of the reaction tube 212 is restricted when the cleaning number-of-times CN2 of the reaction tube 212 is equal to or more than the preset number-of-times threshold NT2. Here, the controller 400 stores the cleaning number-of-times CN2 of performing the cleaning processing for the reaction tube 212 in the memory 403 as the processing container cleaning information 413. There is a possibility that the reaction tube 212 is over-etched by performing the cleaning processing on the reaction tube 212. Therefore, there is a possibility that the reaction tube 212 cannot withstand the substrate processing by repeating the cleaning processing. In this case, the reaction tube 212 is replaced. As described above, a life of the reaction tube 212 can be grasped by setting the number-of-times threshold NT2 to the cleaning number-of-times CN2 of the reaction tube 212. Then, the controller 400 gives a notification of a replacement time of the reaction tube 212 before the reaction tube 212 becomes unusable (in other words, before an end of the life). Specifically, the determinator 408 of the controller 400 compares the cleaning number-of-times CN2 with the number-of-times threshold NT2, and when the cleaning number-of-times CN2 is equal to or more than the number-of-times threshold NT2, the determinator 408 notifies the displayer 424 of display of the fact that use of the reaction tube 212 is restricted. By displaying that use of the reaction tube 212 is restricted in this manner on the displayer 424, an operator can recognize that the reaction tube 212 is to be replaced. Note that a notification indicating that use of the reaction tube 212 is restricted may be given by voice, or the fact that use of the reaction tube 212 is restricted may be displayed on an external displayer or the like via a communication line.

In the present embodiment, as illustrated in FIG. 10, the accumulated film thickness value FT1 of each boat 240, the film thickness threshold TT1 of each boat 240, the accumulated film thickness value FT2 of the reaction tube 212, and the film thickness threshold TT2 of the reaction tube 212 are displayed on the displayer 424. Therefore, the cleaning start condition of each boat 240 and the cleaning start condition of the reaction tube 212 can be grasped.

In the present embodiment, the calculator 407 of the controller 400 calculates the cleaning time CT1 of each boat 240 on the basis of the film thickness threshold TT1 of each boat 240. In this manner, the calculator 407 automatically calculates the cleaning time CT1, whereby it is possible to suppress an erroneous operation such as an input mistake by an operator.

In the present embodiment, the calculator 407 of the controller 400 calculates the cleaning time CT2 of the reaction tube 212 on the basis of the film thickness threshold TT2 of the reaction tube 212. In this manner, the calculator 407 automatically calculates the cleaning time CT2, whereby it is possible to suppress an erroneous operation such as an input mistake by an operator.

In the present embodiment, when the cleaning processing of the boat 240 is completed, the accumulated film thickness value FT1 of the boat 240 for which the cleaning processing is completed is cleared (zero-cleared). Therefore, the substrate processing apparatus 100 of the present embodiment can shorten a time from completion of the cleaning processing to start of the substrate processing as compared with, for example, a case where the film thickness of the boat 240 is detected using a film thickness detector after the cleaning processing of the boat 240 is completed and set as the accumulated film thickness value FT1.

In the present embodiment, when the cleaning processing of the reaction tube 212 is completed, the accumulated film thickness value FT2 of the reaction tube 212 for which the cleaning processing is completed is cleared (zero-cleared). Therefore, the substrate processing apparatus 100 of the present embodiment can shorten a time from completion of the cleaning processing to start of the substrate processing as compared with, for example, a case where the film thickness of the reaction tube 212 is detected using a film thickness detector after the cleaning processing of the reaction tube 212 is completed and set as the accumulated film thickness value FT2.

### OTHER EMBODIMENTS

In the embodiment illustrated in FIGS. 5A to 5E, the apparatus is operated by placing the substrates S on all the three boats 240, but the present disclosure is not limited to this configuration. The apparatus may be operated by placing the substrates S on two boats 240, or the apparatus may be operated by placing the substrate S on one boat 240, among the three boats 240.

In addition, an example has been described in which a set of the reactor 200 and the transfer chamber 270 is used as the substrate processing apparatus 100, but the present disclosure is not limited thereto. For example, a plurality of sets of the reactor 200 and the transfer chamber 270 may be connected to the transfer chamber 140. In addition, a plurality of reactors 200 may be disposed in an upper portion of the transfer chamber 270. In this case, substrate processing of the substrate S can be performed by the plurality of reactors 200 in parallel. In addition, the plurality of reactors 200 may be chambers in which different types of substrate processing are performed. In this case, after substrate processing is performed in the first reactor 200, another type of substrate processing may be performed in the next reactor 200.

In addition, in the substrate processing apparatus 100, the boat 240 to be used may be selectively used depending on the type of film to be formed on the substrate S. That is, in the boat 240 having a high usage ratio, a film that has adhered progresses quickly, and therefore the cleaning processing is frequently performed on the boat 240. On the other hand, in the boat 240 having a low usage ratio, a progress of a film is slow, and therefore the cleaning processing does not have to be frequently performed on the boat 240.

In addition, for example, in the embodiments described above, as an example, a case has been described where a film is formed using the first gas and the second gas in the film forming processing performed by the substrate processing apparatus, but the present embodiment is not limited thereto. That is, the first gas may be any of various elements, for example, titanium (Ti), zirconium (Zr), and hafnium (Hf), instead of a silicon-containing gas. The second gas may be, for example, a second element-containing gas containing 0 instead of a nitrogen-containing gas.

According to the present disclosure, it is possible to suppress over-etching of a processing container caused by cleaning processing of a support that supports a substrate.

What is claimed is:

1. A substrate processing apparatus comprising:
a processing container in which a support capable of supporting at least one substrate is loaded, and in which the substrate is processed;
a transfer chamber including a plurality of the supports and capable of switching the supports and transferring the supports to the processing container;
a gas supplier that supplies a processing gas for depositing a film and a cleaning gas for removing the deposited film into the processing container; and
a controller including a determinator that determines whether a film adhering to the support by the processing of the substrate has reached a cleaning start condition, and capable of controlling a notification indicating that cleaning processing of the support can be performed when the support has reached the cleaning start condition from a determination result of the determinator.

2. The substrate processing apparatus according to claim 1, wherein:
a cleaning time is set for each of the supports, and
the controller is capable of performing control to perform the cleaning processing during the cleaning time set for the support that has reached the cleaning start condition.

3. The substrate processing apparatus according to claim 1, further comprising:
a memory that stores the cleaning start condition and a number of times of cleaning each of the supports, wherein:
the controller updates the number of times of cleaning the support that has been subjected to the cleaning processing every time the cleaning processing is performed.

4. The substrate processing apparatus according to claim 3, wherein:
the controller restricts use of the support in which the number of times of cleaning is equal to or more than the preset number-of-times threshold.

5. The substrate processing apparatus according to claim 4, further comprising:
a display, wherein; the controller causes the display to display that there is the support whose use is restricted.

6. The substrate processing apparatus according to claim 1, wherein:
the cleaning start condition includes a film thickness threshold preset for each of the supports, and
the determinator determines that the support has reached the cleaning start condition when an accumulated film thickness value of a film adhering to each of the supports is equal to or more than the film thickness threshold of each of the supports.

7. The substrate processing apparatus according to claim 6, wherein:
the controller calculates a cleaning time of each of the supports based on the film thickness threshold or the accumulated film thickness value of each of the supports.

8. The substrate processing apparatus according to claim 7, wherein:
when the cleaning processing of the support is completed, the controller clears the accumulated film thickness value of the support for which the cleaning process is completed.

9. The substrate processing apparatus according to claim 6, further comprising a display, wherein:
the controller causes the display to display a determination result of the determinator.

10. The substrate processing apparatus according to claim 1, wherein:
a cleaning start condition of the processing container is set,
the determinator determines whether a film adhering to the processing container by processing of the substrate has reached the cleaning start condition, and
the controller is capable of performing control such that the processing container is subjected to cleaning processing according to a cleaning time set for the processing container when the processing container has reached the cleaning start condition from a determination result of the determinator.

11. The substrate processing apparatus according to claim 10, wherein:
the controller is capable of performing control to perform cleaning processing only on the processing container according to the cleaning time of the processing container.

12. The substrate processing apparatus according to claim 10, wherein:
the cleaning start condition includes a film thickness threshold preset for the processing container, and
the determinator determines that the processing container has reached the cleaning start condition when an accumulated film thickness value of a film adhering to the processing container is equal to or more than the film thickness threshold.

13. The substrate processing apparatus according to claim 12, wherein:
the controller calculates the cleaning time of the processing container based on the film thickness threshold or the accumulated film thickness value of the processing container.

14. The substrate processing apparatus according to claim 12, wherein:
when the cleaning processing of the processing container is completed, the controller clears the accumulated film thickness value of the processing container.

15. The substrate processing apparatus according to claim 10, further comprising:
a memory that stores the cleaning start condition and a cleaning number-of-times of the processing container, wherein;
the controller updates the number of times of cleaning of the processing container every time the cleaning processing of the processing container is performed.

16. The substrate processing apparatus according to claim 15, wherein:
the controller restricts use of the processing container in which the cleaning number-of-times of the processing container is equal to or more than the preset number-of-times threshold.

17. The substrate processing apparatus according to claim 16, further comprising a displayer, wherein:
the controller causes the displayer to display that there is the processing container whose use is restricted.

18. A substrate processing method, comprising:
processing a support capable of supporting at least one substrate is loaded in a processing container, the substrate by supplying a processing gas for depositing a film;
switching a plurality of the supports and transferring the supports to the processing container;
determining whether a film adhering to the support by the processing of the substrate has reached a cleaning start condition; and
giving a notification indicating that cleaning processing of the support that has reached the cleaning start condition by supplying a cleaning gas for removing the deposited film can be performed when the support has reached the cleaning start condition from the determination result.

19. A method of manufacturing a semiconductor device, comprising the substrate processing method of claim 18.

20. A non-transitory computer-readable recording medium storing a program that causes, by a computer, a substrate processing apparatus to perform a process comprising:
processing a support capable of supporting at least one substrate is loaded in a processing container, the substrate by supplying a processing gas for depositing a film;
switching a plurality of the supports and transferring the supports to the processing container;
determining whether a film adhering to the support by the processing of the substrate has reached a cleaning start condition; and
giving a notification indicating that cleaning processing of the support that has reached the cleaning start condition by supplying a cleaning gas for removing the deposited film can be performed when the support has reached the cleaning start condition from the determination result.
